(19) United States
(12) Patent Application Publication
(10) Pub. No.: US 2026/0197794 A1
(43) Pub. Date: Jul. 9, 2026

(54) CONTROL METHOD FOR POSITION MANAGEMENT SYSTEM AND POSITION MANAGEMENT SYSTEM

(71) Applicant: SEIKO EPSON CORPORATION, Tokyo (JP)

(72) Inventor: Naoki GOBARA, SHIOJIRI-SHI (JP)

(73) Assignee: SEIKO EPSON CORPORATION, Tokyo (JP)

(21) Appl. No.: 19/439,495

(22) Filed: Jan. 5, 2026

(30) Foreign Application Priority Data
Jan. 7, 2025 (JP) 2025-002165

(51) Int. Cl. H04W 64/00

(52) U.S. Cl. CPC H04W 64/00

(57) ABSTRACT

A position management system acquires, from a device configured to execute a first positioning method using a satellite signal, position information about the device, determines whether a target person is present in a check area, and acquires the position information by a second positioning method for measuring a position of the device based on relative positions of a plurality of apparatuses and the device when it is determined that the target person is present in the check area.

The present application is based on, and claims priority from JP Application Serial Number 2025-002165, filed January 7, 2025, the disclosure of which is hereby incorporated by reference herein in its entirety.

### BACKGROUND

### 1. Technical Field

The present disclosure relates to a control method for a position management system that manages a position of a target person, and a position management system used for position management of a target person.

### 2. Related Art

In competitions where players compete against each other over indoor and outdoor courses, it is necessary to accurately measure a start of a player, a time the player takes to pass through predetermined points, a goal, and the like, and a method is used in which participants are required to wear RF tags. In such a method, it is necessary to set a reader for recognizing the RF tags at a measurement point or the like, which places a heavy load on the operation.

A known system that does not have restrictions on reader placement, such as the method using the RF tags, is to use position information measured by GPS and map information including a course to course-match positions of players on a map (JP-A-2016-176863).

JP-A-2016-176863 is an example of the related art.

When using GPS positioning as in the above system, the positioning satisfying the necessary accuracy cannot be performed at a specific place where the positioning is desired to be performed with high accuracy, for example, the measurement point due to an influence of multipath or the like.

### SUMMARY

A method of an aspect of the present disclosure is a control method for a position management system that manages a position of a target person using a server, a device attached to the target person, and a plurality of apparatuses disposed in a predetermined range set in advance, the control method including: acquiring, from the device configured to execute a first positioning method for acquiring position information based on a satellite signal, the position information about the device acquired by the first positioning method; determining whether the target person is present in the predetermined range; and causing the device to stop execution of the first positioning method and causing the device to acquire the position information by a second positioning method different from the first positioning method when it is determined that the target person is present in the predetermined range, in which the second positioning method is a positioning method for measuring a position of the device based on relative positions between the plurality of apparatuses and the device.

A system of an aspect of the present disclosure is a position management system for managing a position of a target person using a server, a device attached to the target person, and a plurality of apparatuses disposed in a predetermined range set in advance, in which from the device configured to execute a first positioning method for acquiring position information based on a satellite signal, the position information about the device acquired by the first positioning method is acquired, whether the target person is present in the predetermined range is determined, the device is caused to stop execution of the first positioning method, and the device is caused to acquire the position information by a second positioning method different from the first positioning method when it is determined that the target person is present in the predetermined range, and the second positioning method is a positioning method for measuring a position of the device based on relative positions between the plurality of apparatuses and the device.

### BRIEF DESCRIPTION OF THE DRAWINGS

FIG. 1 is a conceptual diagram illustrating an outline of a position management system according to a first embodiment.

FIG. 2 is a block diagram illustrating a device in the position management system.

FIG. 3 is a block diagram illustrating a positioning anchor in the position management system.

FIG. 4 is a block diagram illustrating a server in the position management system.

FIG. 5 is a functional block diagram of the position management system.

FIG. 6 is a diagram illustrating an operation of the position management system.

FIG. 7 is a diagram illustrating an example of the operation of the position management system.

FIG. 8 is a conceptual diagram illustrating an outline of a position management system according to a second embodiment.

FIG. 9 is a block diagram illustrating a monitoring unit in the position management system.

FIG. 10 is a block diagram illustrating a device in the position management system.

FIG. 11 is a diagram illustrating an example of the operation of the position management system.

FIG. 12 is a diagram illustrating an example of an operation of the position management system.

### DESCRIPTION OF EMBODIMENTS

### First Embodiment

Hereinafter, a position management system and a control method thereof according to a first embodiment of the present disclosure will be described with reference to the drawings.

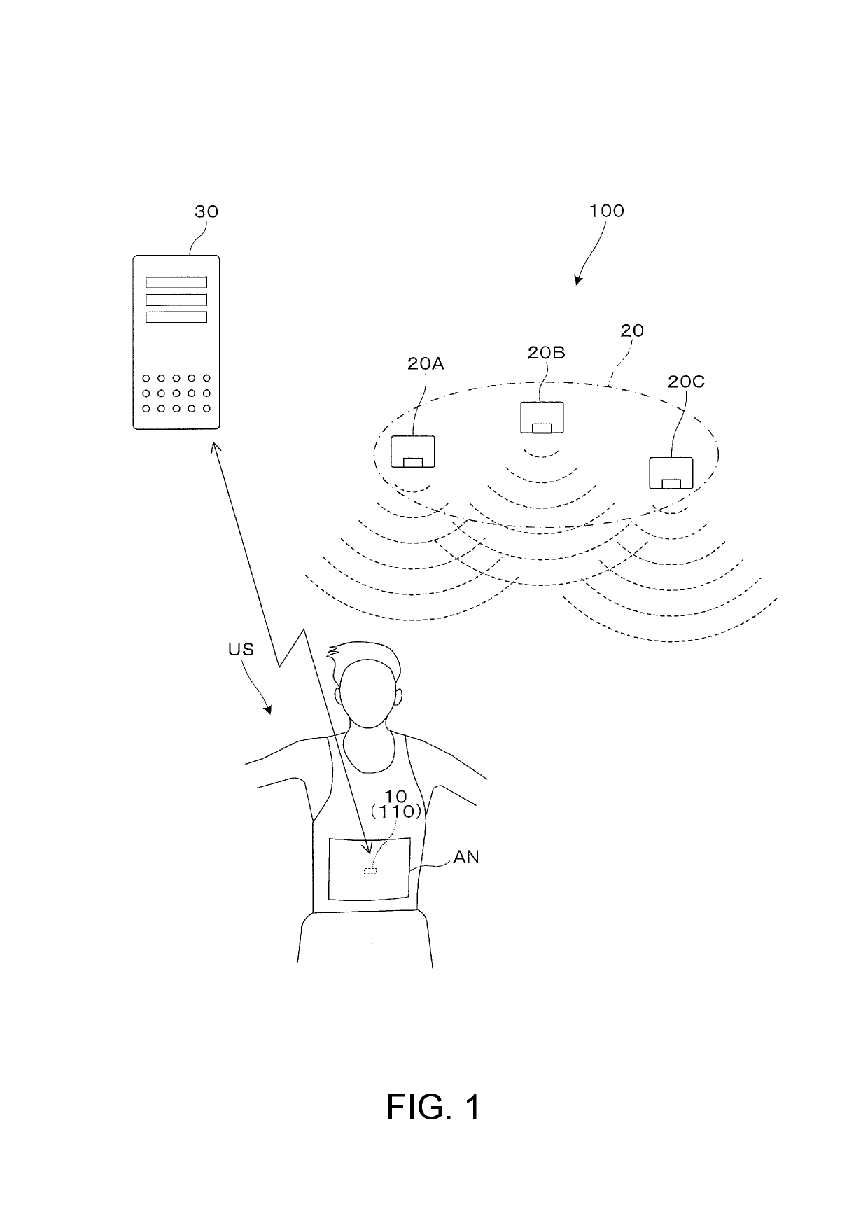

Referring to FIG. 1, a position management system 100 is used to manage position information about a target person US who participates in an operation of an outdoor sport competition, such as a marathon, together with time information. The position management system 100 includes a large number of wearable terminals 10 (only one of which is illustrated in the drawing) to be worn by each target person US, an anchor set 20 capable of detecting a position of the wearable terminal 10 with high accuracy, and a server 30 that remotely manages a state of the wearable terminal 10 and the like and collects information. In the case of outdoor athletic sports, the wearable terminal 10 is attached to, for example, a back side of an athletic number card AN. The wearable terminal 10 may be worn on an arm of each target person US using an arm band, or the wearable terminal 10 may be worn on each target person US by wearing inner wear to which the wearable terminal 10 can be attached. In addition, the wearable terminal 10 may be attached to a shoe of each target person US. In this case, the wearable terminal 10 is attached to the shoe by fastening the wearable terminal 10 to a shoelace.

Digital information can be exchanged between the wearable terminal 10 and the server 30 by inter-terminal wireless communication, such as wireless LAN represented by wireless fidelity (registered trademark) or Wi-Fi (registered trademark). The digital information may be exchanged between the wearable terminal 10 and the server 30 not only by Wi-Fi but also by inter-terminal wireless communication, such as Bluetooth (registered trademark). Alternatively, LPWA communication, such as CatM1 or NB-IoT, may be used.

Between each of positioning anchors 20A, 20B, and 20C constituting the anchor set 20 and the wearable terminal 10, data signals can be exchanged by unidirectional or bidirectional ultra wide band (UWB) communication. Here, UWB communication, in a broad sense, refers to wireless communication that uses signals dispersed over a wide bandwidth and that uses impulse or carrier wave or wideband modulation. UWB communication, in a narrow sense, refers to wireless communication that uses signals dispersed over a wide bandwidth and that uses an impulse radio ultra-wideband (IR-UWB) method using direct sequence modulation. Specifically, in the narrow sense, UWB communication specifically means that it satisfies, for example, "IEEE 802.15.4z" or related standard specifications. In the present specification, when referring to UWB communication, unless otherwise specified, it is used to mean UWB communication in the narrow sense.

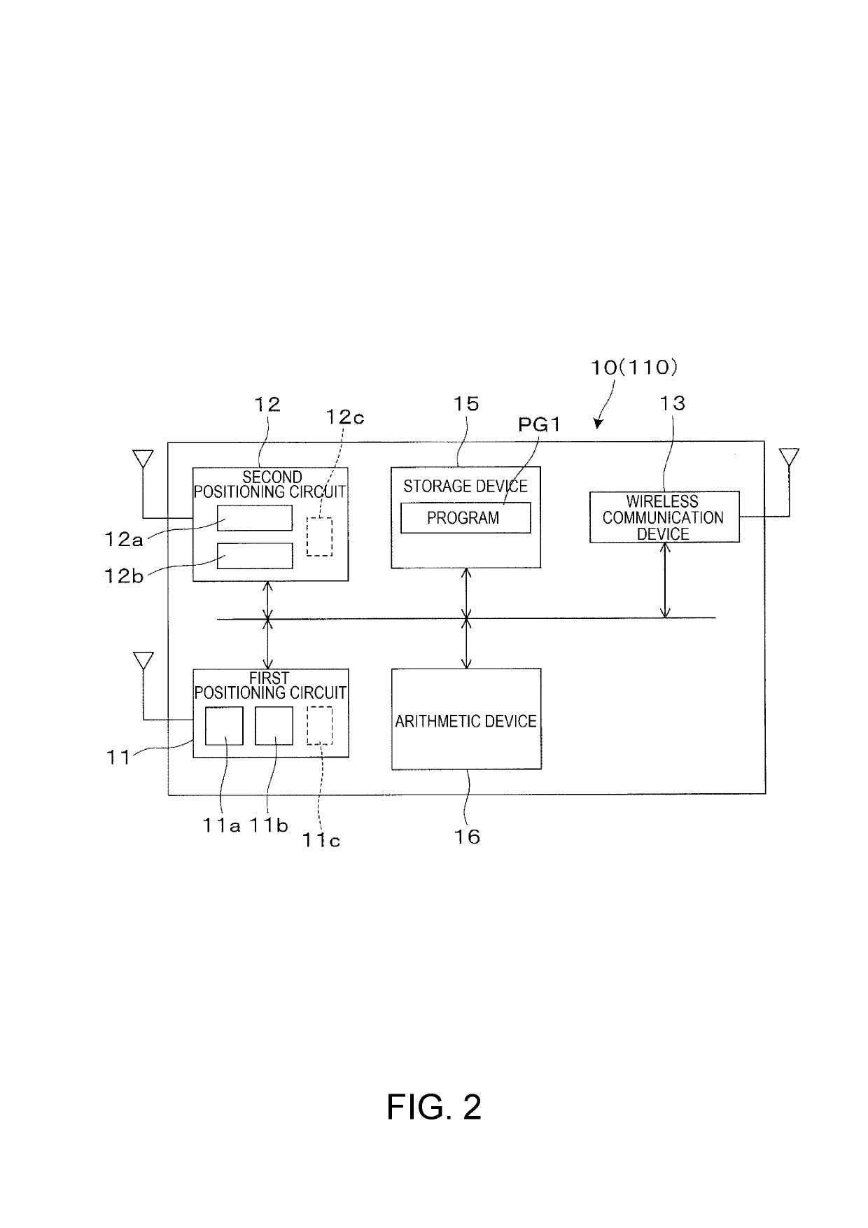

Referring to FIG. 2, the wearable terminal 10, which is a device 110, includes a first positioning circuit 11, a second positioning circuit 12, a wireless communication device 13, a storage device 15, and an arithmetic device 16.

The first positioning circuit 11 is a satellite positioning circuit including, for example, a global navigation satellite system (GNSS) receiver, and enables measurement of a current position of the wearable terminal 10 on the ground using an artificial satellite. The first positioning circuit 11 executes positioning by a first positioning method, and includes, for example, a high-frequency circuit 11a, a code correlation unit 11b, and a microprocessor 11c. In the positioning by the first positioning circuit 11, for example, messages including ephemeris data and the like are received from four artificial satellites, and propagation times is calculated. Then, the current position of the wearable terminal 10 can be measured with predetermined accuracy based on four propagation times, with three-dimensional coordinate values of the wearable terminal 10 and a time error of the first positioning circuit 11 as unknowns. The positioning by the first positioning circuit 11 is absolute and is based on the ground. When a time of the artificial satellite and a time of the first positioning circuit 11 are precisely synchronized, the current position of the wearable terminal 10 on the ground can also be measured using three artificial satellites. The first positioning circuit 11 is not limited to being based only on signals from the artificial satellite, and for example, may calculate positioning information with relatively high accuracy by performing correction using correction information received from a positioning accuracy station such as an electronic reference point.

The second positioning circuit 12 is a UWB circuit that acquires information about positioning from the positioning anchors 20A, 20B, and 20C by UWB communication, communicates with each of the positioning anchors 20A, 20B, and 20C by the impulse radio ultra-wideband method, and measures a relative current position of the wearable terminal 10, that is, the device 110 with respect to each of the positioning anchors 20A, 20B, and 20C with high accuracy of several centimeters or less. The second positioning circuit 12 executes positioning by a second positioning method to determine a relative position of the wearable terminal 10 with respect to each of the positioning anchors 20A, 20B, and 20C, and may include, for example, a transmission circuit 12a and a reception circuit 12b and may incorporate a microprocessor 12c for digital signal processing. Although not illustrated, the transmission circuit 12a includes, for example, a pulse generation unit and a pulse modulation unit, and the reception circuit 12b includes, for example, a synchronization circuit and a correlator.

Here, the second positioning method by UWB communication will be described. For example, the position of the wearable terminal 10 can be specified by measuring distances from the wearable terminal 10 to the positioning anchors 20A, 20B, and 20C. At this time, a principle of three-point positioning, which is also used in a satellite positioning system, is used. As a method for measuring the distance from the wearable terminal 10 to each of the positioning anchors 20A, 20B, and 20C, the simplest method is a method (RSSI method) using wave intensity. In this method, the distance is calculated according to a radio wave intensity of the signals of the positioning anchors 20A, 20B, and 20C received on a wearable terminal 10 side which is the receiver. This method can reduce processing load on the wearable terminal 10 and can reduce power consumed by the wearable terminal 10 as compared with a second method and a third method to be described later. The second method is a time of flight (ToF) method for measuring a distance using a reception time of a radio wave. In this method, transmission and reception of signals are performed a plurality of times between the positioning anchors 20A, 20B, and 20C and the wearable terminal 10 which is a receiver, and a distance is calculated based on a time difference (including a propagation time between apparatuses) from transmission to reception of the radio wave. This method can observe the distance with higher accuracy than the first method. The third method is a time difference of arrival (TDoA) method. In this method, the time in the positioning anchors 20A, 20B, and 20C and the time in the wearable terminal 10 are synchronized in advance, and a distance is measured by comparing an arrival time difference between each of the positioning anchors 20A, 20B, and 20C and the wearable terminal 10. In this method, since the positioning anchors 20A, 20B, and 20C perform only transmission and the wearable terminal 10 performs only reception, the wearable terminal 10 can be operated with lower power consumption than the second method.

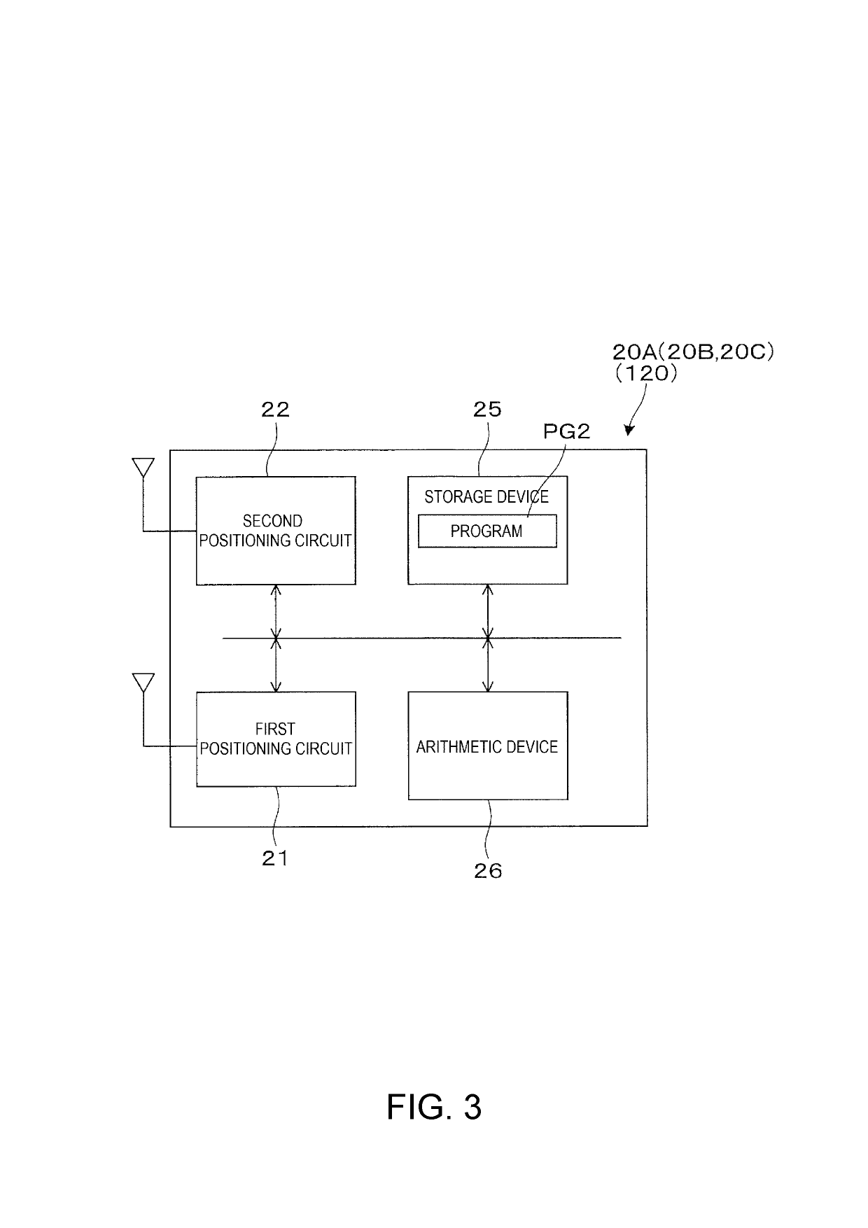

As will be described later, the positioning anchor 20A can measure the current position of the positioning anchor 20A itself on the ground using an artificial satellite by a first positioning circuit 21 (see FIG. 3). Since the positioning anchor 20A is fixed at a specific position in a course MC and can stably receive a satellite signal transmitted from an artificial satellite, the positioning anchor 20A calculates positioning information about the wearable terminal 10 with higher accuracy than the first positioning circuit 11. The wearable terminal 10 can receive the current position held by the positioning anchors 20A, 20B, and 20C as supplementary information from the positioning anchors 20A, 20B, and 20C. By combining the positioning information about the wearable terminal 10 obtained by the second positioning method and the current position information received from the positioning anchors 20A, 20B, and 20C, it is possible to obtain absolute positioning information about the wearable terminal 10 based on the ground, which is the positioning information about the wearable terminal 10 with higher accuracy than the first positioning circuit 11 in principle.

The wireless communication device 13 enables the wearable terminal 10 to be communicably connected to the server 30. Specifically, the wireless communication device 13 enables inter-terminal wireless communication such as Bluetooth or a wireless LAN. Accordingly, the wireless communication device 13 can transmit data or messages to the server 30 and receive commands or the like from the server 30.

The storage device 15 stores a program PG1 including various types of data and commands for the wearable terminal 10 to execute processing to be described later. The storage device 15 is used as a non-transitory tangible storage medium that stores these types of data and commands. The storage device 15 is a semiconductor storage device including a RAM, a ROM, a flash memory, and the like.

The arithmetic device 16 reads the program PG1 including a command and data for executing at least a part of processing to be described later from the storage device 15 and executes the program PG1. The arithmetic device 16 includes a central processing unit (CPU) and the like. By reading and executing the program PG1, the arithmetic device 16 implements a function of executing the first positioning method of operating the first positioning circuit 11 to receive the satellite signal from the artificial satellite and acquiring the position information about the wearable terminal 10 based on the satellite signal, and a function of executing the second positioning method of operating the second positioning circuit 12 to communicate with the anchor set 20 and positioning the position of the wearable terminal 10 based on the relative distances between the wearable terminal 10 and the positioning anchors 20A, 20B, and 20C determined based on a communication result. By reading and executing the program PG1, the arithmetic device 16 executing a function of communicating with the server 30, periodically transmitting data specifying requested position information and time information corresponding thereto together with identification information, receiving a command requesting execution of the first positioning method or the second positioning method, and executing the corresponding positioning method in response to the request.

The positioning information calculated on the wearable terminal 10 side is calculated, for example, every one second for a first positioning result by the first positioning method and transmitted to the server 30 by wireless communication every several seconds, and is calculated, for example, 10 Hz (every 100 msec) for a second positioning result by the second positioning method and transmitted to the server 30 by wireless communication every one second. Since the second positioning result by the second positioning method is used to measure the time when the target person US wearing the wearable terminal 10 passes through a measurement point, it is necessary to measure the position at a positioning interval shorter than a positioning interval in the first positioning method to calculate a more accurate passage time. Since the server 30 also needs to determine whether the target person US has passed through the measurement point in real time to some extent, the second positioning result may be transmitted to the server 30 at an interval shorter than a transmission interval at which the first positioning result is transmitted to the server 30.

In the positioning by the first positioning method, it is not necessary to perform calculation by the first positioning circuit 11, and the arithmetic device 16 can perform positioning for determining a three-dimensional position of the wearable terminal 10 based on information about a distance between the wearable terminal 10 and the artificial satellite obtained by the first positioning circuit 11. In the positioning by the second positioning method as well, it is not necessary to perform calculation by the second positioning circuit 12, and the arithmetic device 16 can perform positioning for determining the three-dimensional position of the wearable terminal 10 based on distance information obtained by the second positioning circuit 12.

In the positioning by the second positioning method, when distance information between the positioning anchors 20A, 20B, and 20C and the wearable terminal 10 can be acquired in the wearable terminal 10, the position calculation can be performed by the remote server 30 or other servers. Also in the positioning by the first positioning method, when the distance information between the wearable terminal 10 and the artificial satellite can be acquired in the wearable terminal 10, the position calculation can be performed by the remote server 30 or other servers.

Referring to FIG. 3, the positioning anchor 20A, which is an apparatus 120, includes the first positioning circuit 21, a second positioning circuit 22, a storage device 25, and an arithmetic device 26.

The first positioning circuit 21 is a satellite positioning circuit including, for example, a GNSS receiver, and enables measurement of a current position of the positioning anchor 20A on the ground using an artificial satellite. The first positioning circuit 21 executes positioning by the first positioning method, and is similar to the first positioning circuit 11 of the wearable terminal 10, but performs positioning with higher accuracy than the first positioning circuit 11. That is, the first positioning circuit 21 of the positioning anchor 20A performs correction using correction information received from a positioning accuracy station such as an electronic reference point, and calculates positioning information about the wearable terminal 10 with higher accuracy than the first positioning circuit 11.

The second positioning circuit 22 is a UWB circuit that provides information about positioning to the wearable terminal 10, which is the device 110, by UWB communication. The second positioning circuit 22 of the positioning anchor 20A executes positioning by the second positioning method, and is similar to the second positioning circuit 12 of the wearable terminal 10. When the positioning anchor 20A operates with an RSSI method or the TDoA method, only a transmission circuit is sufficient, and a reception circuit is unnecessary. In contrast, when the positioning anchor 20A operates with the ToF method, a transmission circuit and a reception circuit are required.

In the above description, the positioning anchor 20A is a unidirectional transmitter or a passive node, and distance measurement or positioning is performed on the wearable terminal 10 side. However, the distance from the positioning anchor 20 to the wearable terminal 10 may be measured and the current position of the wearable terminal 10 may be measured on the wearable terminal 10 side, and a distance measurement value or a positioning result may be transmitted to the wearable terminal 10 on the positioning anchor 20A side. Also in this case, the wearable terminal 10, which is the device 110, acquires the position information by the second positioning method.

The storage device 25 stores a program PG2 including various types of data and commands for the positioning anchor 20A to execute processing to be described later. The storage device 25 is used as a non-transitory tangible storage medium that stores these types of data and commands. The storage device 25 is a semiconductor storage device including a RAM, a ROM, a flash memory, and the like.

The arithmetic device 26 reads the program PG2 including a command and data for executing at least a part of processing to be described later from the storage device 25 and executes the program PG2. The arithmetic device 26 includes a central processing unit (CPU) and the like. By reading and executing the program PG2, the arithmetic device 26 implements a function of executing the first positioning method of operating the first positioning circuit 21 to receive a satellite signal from an artificial satellite and acquiring position information about the positioning anchor 20A based on the satellite signal, and a function of operating the second positioning circuit 22 to enable UWB communication with the wearable terminal 10 and enabling the wearable terminal 10 to acquire the positioning information by the second positioning method.

Since the other positioning anchors 20B and 20C have the same structure as the positioning anchor 20A and function in the same manner as the positioning anchor 20A, the description thereof will be omitted. When the current position of the wearable terminal 10 is measured on a side of the positioning anchors 20A, 20B, and 20C, for example, the other positioning anchors 20B and 20C transmit distance calculation values from the positioning anchors 20B and 20C to the wearable terminal 10 to the positioning anchor 20A, and the positioning anchor 20A measures the current position of the wearable terminal 10 by using a distance calculation value from the positioning anchor 20A to the wearable terminal 10 and the received distance calculation values.

When the positioning anchor 20A always measures the current position of the wearable terminal 10, the processing load increases in the positioning anchor 20A. Therefore, it is necessary to distribute the load to the positioning anchors 20B and 20C. For example, in the anchor set 20, a positioning anchor having the highest communication strength with the wearable terminal 10 is caused to calculate positioning. Accordingly, it is possible to change the positioning anchor that measures the current position of the wearable terminal 10 according to the position of the target person US, that is, the wearable terminal 10, and it is possible to distribute the load generated when the current position of the wearable terminal 10 is measured by the positioning anchors 20A, 20B, and 20C.

To compare the communication strength between the wearable terminal 10 and each of the positioning anchors 20A, 20B, and 20C, for example, each of the positioning anchors 20A, 20B, and 20C transmits information about the communication strength between the wearable terminal 10 and each of the positioning anchors 20A, 20B, and 20C to another positioning anchor, and compares the communication strength between the wearable terminal 10 and another positioning anchor transmitted from another positioning anchor 20 and the communication strength between itself and the wearable terminal 10.

As another method for distributing the load generated when measuring the current position of the wearable terminal 10 by the positioning anchors 20A, 20B, and 20C, by assigning a positioning anchor that performs calculation in advance according to identification information about the target person US or the wearable terminal 10, positioning can be calculated using a positioning anchor designated according to the identification information about the target person US.

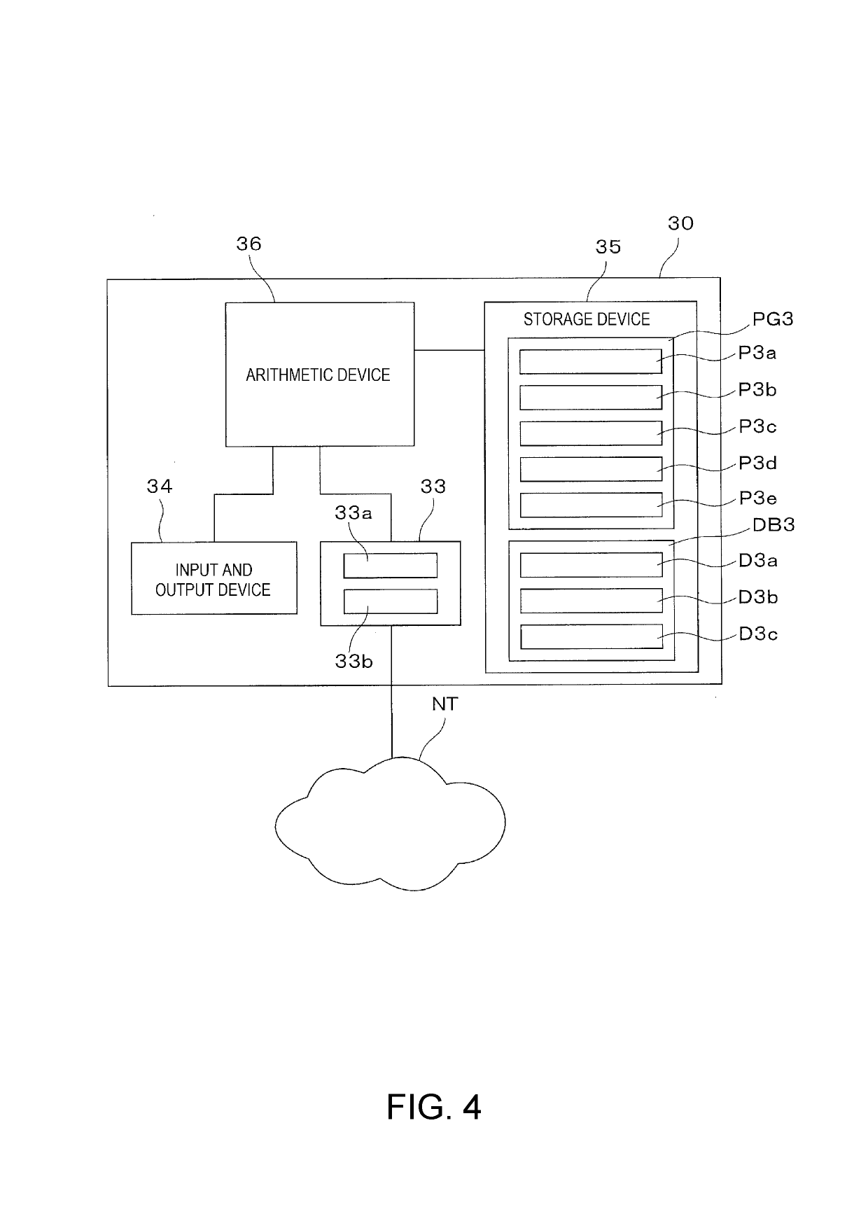

Referring to FIG. 4, the server 30 includes a communication device 33, an input and output device 34, a storage device 35, and an arithmetic device 36.

The communication device 33 includes a first communication circuit 33a that enables inter-terminal wireless communication, and a second communication circuit 33b for connecting to a mobile phone line. The first communication circuit 33a enables the server 30 to communicably connect to the wearable terminal 10. Specifically, the first communication circuit 33a enables inter-terminal wireless communication such as Bluetooth or a wireless LAN. Accordingly, the first communication circuit 33a can transmit a command or the like to the wearable terminal 10 and receive data or a message from the wearable terminal 10. The second communication circuit 33b enables the server 30 to connect to a network NT such as the Internet. The communication device 33 includes various interfaces, such as a network interface card (NIC) and a universal serial bus (USB).

The input and output device 34 receives information for the arithmetic device 36 to execute processing. The input and output device 34 outputs a result of processing executed by the arithmetic device 36. The input and output device 34 includes various input devices and output devices, and includes, for example, a keyboard, a mouse, a display, a microphone, a speaker, and a touch panel.

The storage device 35 stores a database DB3 and a program PG3 that includes various types of data and commands for the server 30 to execute processing to be described later.

The program PG3 includes (1) a first positioning result acquisition program P3a for acquiring the first positioning result by the first positioning method from the wearable terminal 10, (2) a second positioning result acquisition program P3b for acquiring the second positioning result by the second positioning method from the wearable terminal 10, (3) an area check processing program P3c for determining whether the target person US has entered a predetermined range corresponding to a UWB coverage area of the anchor set 20 and determining whether to cause the wearable terminal 10 to execute positioning by the second positioning method, (4) a tracking processing program P3d for continuously acquiring the position information about the wearable terminal 10 or the target person US and the time information when the position information is acquired, and storing the position information and the time information in association with the identification information, and (5) an aggregation processing program P3e for creating aggregation data, such as a passage time of a check point or the measurement point of each target person US, and a section passage time or a speed of each target person US, obtained by tracking processing, and outputting the aggregation data to the input and output device 34.

When the outdoor sport competition to be managed is a marathon, the database DB3 includes (1) a terminal information storage database D3a that stores the position information about each wearable terminal 10, (2) a course information database D3b that stores coordinate information about a course of each competition, and (3) a passage time database D3c that stores the passage time information when each wearable terminal 10 passes through the measurement point. The position information and the time information about each wearable terminal 10 are stored in the terminal information storage database D3a. In the course information database D3b, in addition to the coordinate information along a route of the course, measurement point coordinate information (for example, coordinates of a 5 km location and a 10 km location of a current marathon course) in each course is also stored. In the passage time database D3c, in addition to the passage time of each runner at the measurement point, tracking information before and after the measurement point, a section passage time, and the like are stored. The tracking information is also used to determine whether the runner has appropriately passed through the course.

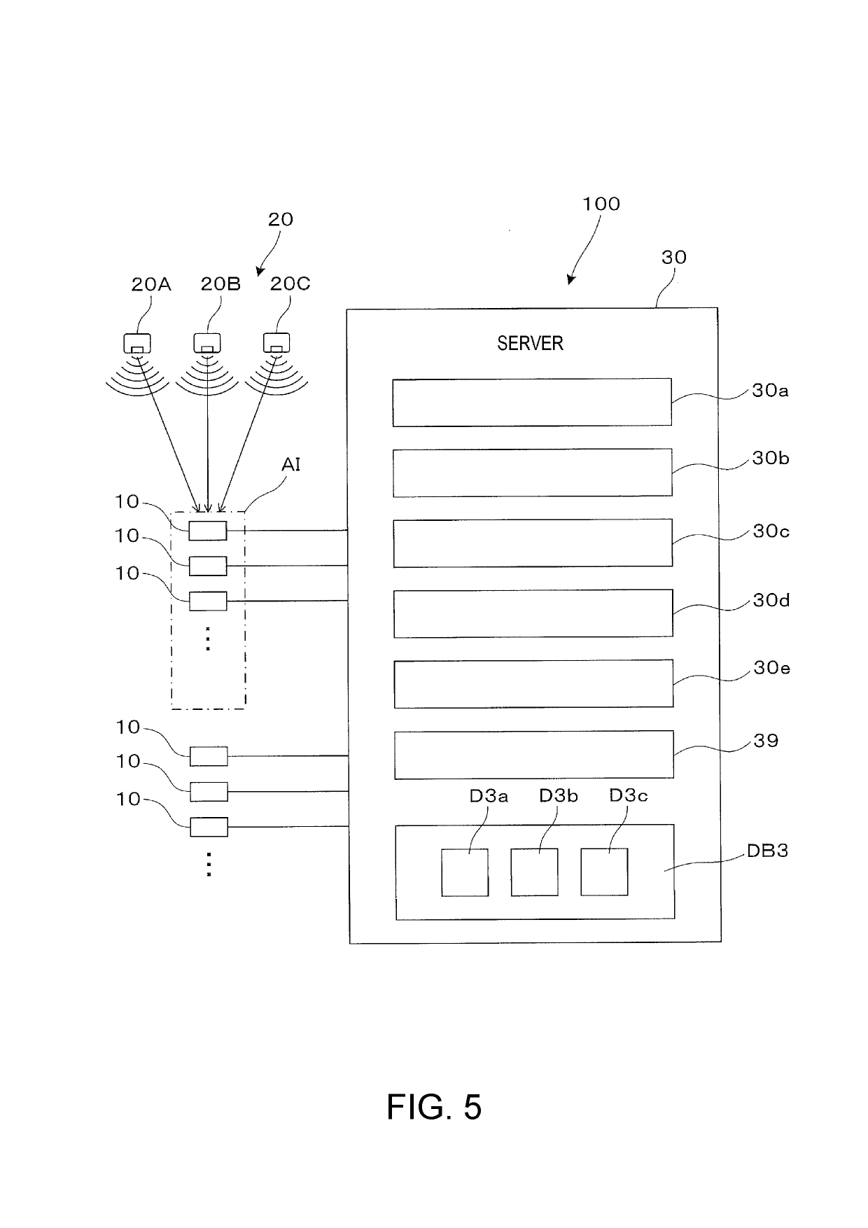

FIG. 5 is a functional block diagram of the position management system 100. The server 30 of the position management system 100 implements a first positioning result acquisition unit 30a, a second positioning result acquisition unit 30b, an area check processing unit 30c, a tracking processing unit 30d, an aggregation processing unit 30e, and a display unit 39 by the arithmetic device 36 illustrated in FIG. 4 reading and executing the program PG3 for position management. The first positioning result acquisition unit 30a acquires the first positioning result acquired from the wearable terminal 10 by the first positioning method. The second positioning result acquisition unit 30b acquires the second positioning result acquired from the wearable terminal 10 by the second positioning method. The area check processing unit 30c refers to the course information database D3b, determines whether to cause the wearable terminal 10 to execute positioning by the second positioning method based on the first positioning result acquired by the first positioning result acquisition unit 30a, and transmits a command to the wearable terminal 10 as necessary. The tracking processing unit 30d continuously acquires the position information about the wearable terminal 10 or the target person US and the time information when the position information is acquired with reference to the identification information recorded in the terminal information storage database D3a, and stores the acquired position information and time information in the passage time database D3c in association with the identification information. The display unit 39 displays the passage time at the measurement point for each target person US corresponding to each wearable terminal 10, and also displays information about completion such as whether the target person US has appropriately passed through the course, the section passage time or a lap time, a final course time, and the like.

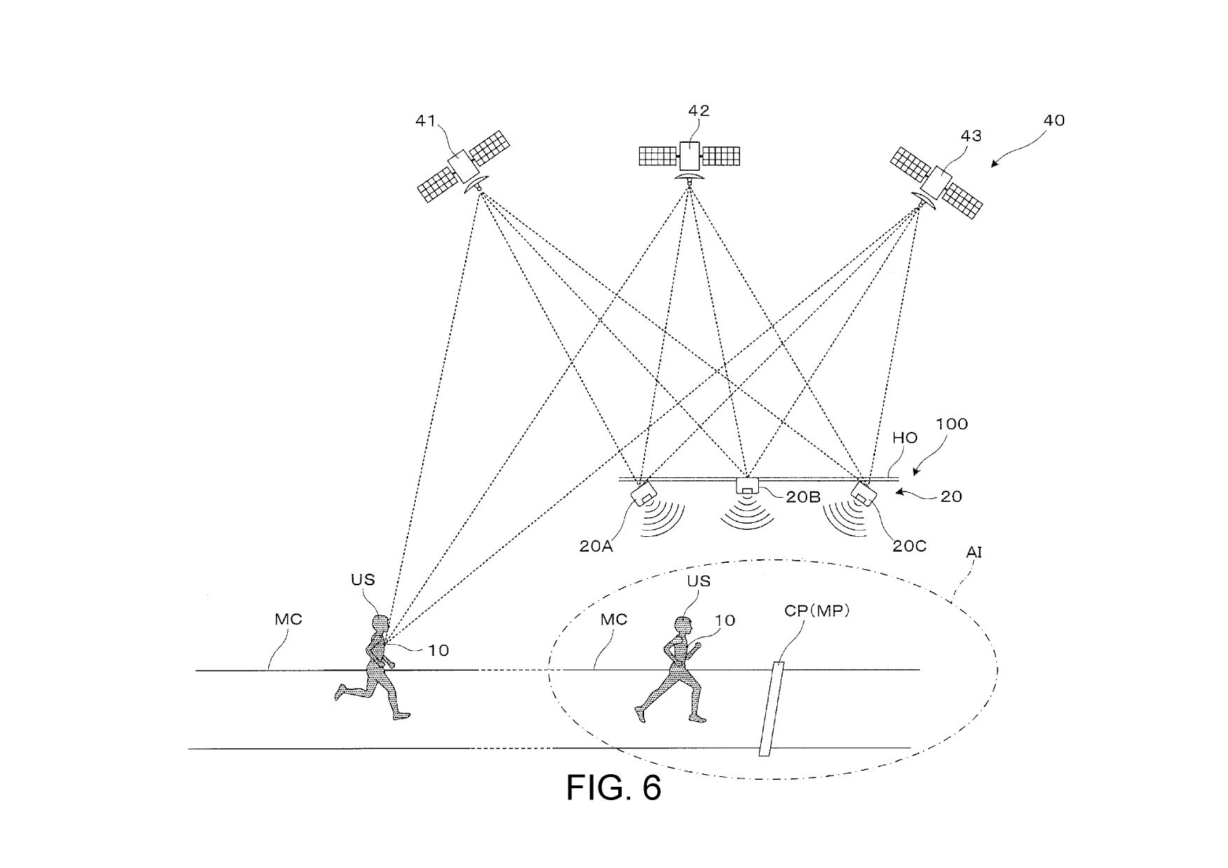

FIG. 6 is a diagram illustrating a measurement state by the position management system 100. A positioning satellite system 40 that enables measurement by the first positioning method includes a plurality of artificial satellites 41, 42, and 43 as elements. The anchor set 20 that enables measurement by the second positioning method includes the positioning anchors 20A, 20B, and 20C, and these positioning anchors 20A, 20B, and 20C are fixed to a stable support device HO and supported in midair.

When the target person US who is a runner wearing the wearable terminal 10 travels on the predetermined course MC and moves outside a check area AI, the wearable terminal 10 acquires the first positioning result by the first positioning method using the positioning satellite system 40 and notifies the server 30 of the position of the target person US. Here, the check area AI is, for example, a circular zone of 50 m centered on coordinates of a measurement point CP, which is a measurement location MP, and includes a space at a predetermined height from a ground surface. The check area AI is determined in advance on the server 30 side and is held as zone information. The check area AI may correspond to a UWB communication range assuming a range in which UWB communication is possible with the anchor set 20. That is, the check area AI is a range in which the second positioning result can be acquired by the second positioning method. The server 30 monitors the first positioning result obtained by the first positioning method, that is, the tracking information about the wearable terminal 10 in real time, and when the server 30 determines that the wearable terminal 10 has entered the check area AI, the server 30 transmits a command to the wearable terminal 10 to start acquisition of the second positioning result by the second positioning method, that is, to command positioning using UWB communication. Since the first positioning result obtained by the first positioning method has an error of about several meters or less, it is possible to accurately specify that the wearable terminal 10 has entered the check area AI to some extent even when using the first positioning method.

At a position where a reception state of the satellite signals from the artificial satellite set in advance in the course MC is poor, the determination may be made according to an acquisition state of the second positioning result, specifically, the number of positioning anchors (for example, three or more) that can communicate with the wearable terminal 10 when the wearable terminal 10 performs UWB communication with the anchor set 20. That is, when the wearable terminal 10 receives a UWB communication signal, the wearable terminal 10 can start acquiring the second positioning result by the second positioning method using the reception as a trigger, transmits the start of positioning by the second positioning method to the server 30 as a message, and continuously transmits the second positioning result to the server 30 in substantially real time.

The server 30 monitors the second positioning result obtained by the second positioning method in real time, and when the server 30 determines that the wearable terminal 10, that is, the target person US has passed through the measurement point CP, the server 30 transmits a command to the wearable terminal 10 to request to end positioning by the second positioning method. In response to the command, the wearable terminal 10 stops the positioning by the second positioning method. The stop of the positioning by the second positioning method may be determined based on the first positioning result obtained by the wearable terminal 10 with the first positioning method. For example, when the wearable terminal 10 determines that the number of satellites for measuring the position of the wearable terminal 10 is insufficient or positioning accuracy is poor even when the positioning is performed based on the first positioning result obtained by the first positioning method, the wearable terminal 10 performs an operation of acquiring the second positioning result by the second positioning method and acquiring the first positioning result by the first positioning method when the number of satellites is ensured or the positioning accuracy is improved.

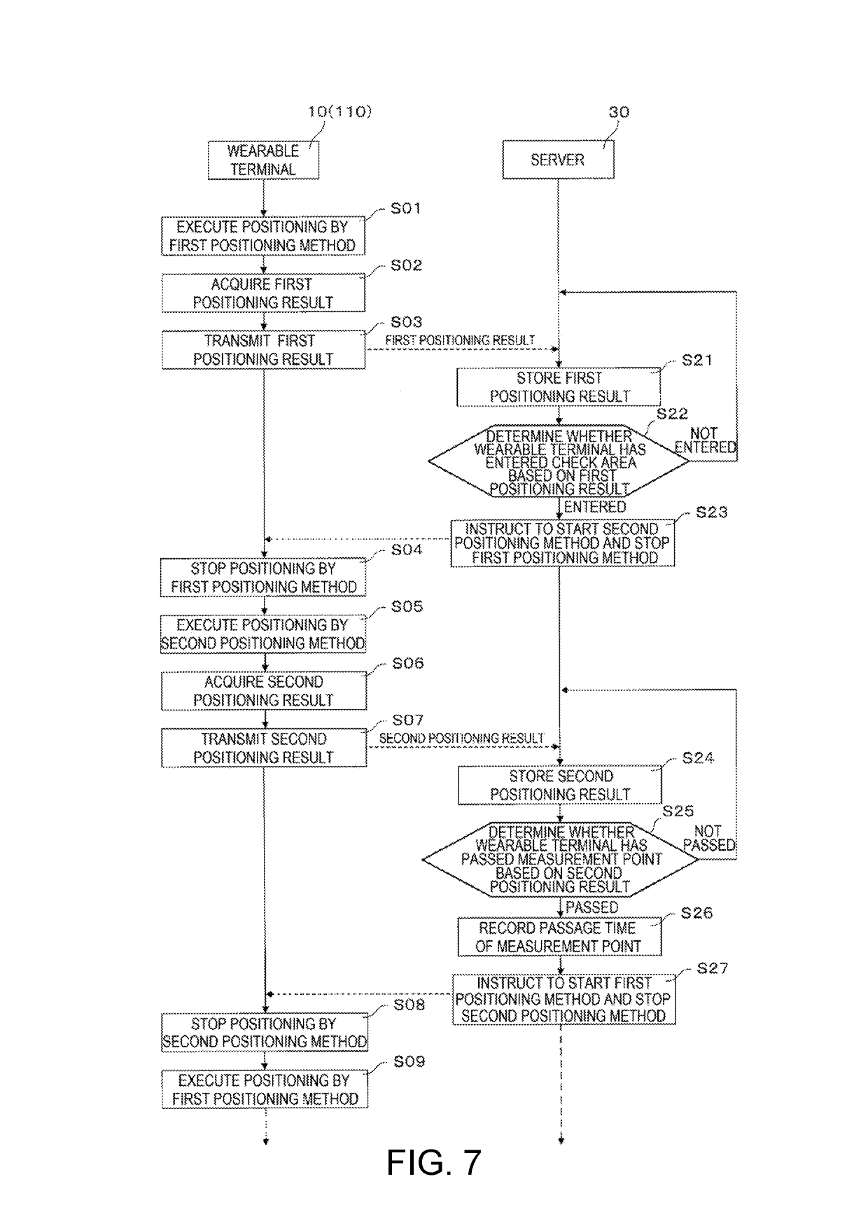

An example of operations of the position management system 100 will be described with reference to FIG. 7. First, the wearable terminal 10 operates the first positioning circuit 11 to start execution of positioning by the first positioning method (step S01), and acquires the first positioning result (step S02). The start of acquisition of the first positioning result can be directly instructed by operating the wearable terminal 10, and may be performed according to an instruction from the server 30. When the first positioning result is acquired, the wearable terminal 10 transmits the first positioning result to the server 30 (step S03). The wearable terminal 10 repeatedly acquires the first positioning result, and when the first positioning result is acquired, the wearable terminal 10 sequentially transmits the first positioning result to the server 30.

The server 30 that receives the first positioning result stores the first positioning result (step S21), and determines whether the wearable terminal 10, that is, the target person US has entered the check area AI corresponding to the UWB coverage area based on the first positioning result (step S22). When the server 30 determines that the wearable terminal 10 is in the check area AI, that is, has entered the check area AI, the server 30 instructs the wearable terminal 10 to start positioning by the second positioning method and to stop positioning by the first positioning method (step S23). When the server 30 determines that the wearable terminal 10, that is, the target person US is outside the check area AI, the server 30 continues to receive the first positioning result.

The wearable terminal 10 instructed to perform the positioning by the second positioning method from the server 30 stops the execution of the positioning by the first positioning method (step S04), operates the second positioning circuit 12 to start the execution of the positioning by the second positioning method (step S05), and acquires the second positioning result (step S06). When the second positioning result is acquired, the wearable terminal 10 transmits the second positioning result to the server 30 (step S07). The wearable terminal 10 repeatedly acquires the second positioning result, and when the second positioning result is acquired, the wearable terminal 10 sequentially transmits the second positioning result to the server 30.

The server 30 that receives the second positioning result stores the second positioning result (step S24), and determines whether the wearable terminal 10, that is, the target person US has passed through the measurement point CP based on the second positioning result (step S25). When the server 30 determines that the wearable terminal 10 has passed the measurement point CP, the server 30 records a passage time of the measurement point CP (step S26), and instructs the wearable terminal 10 to start positioning by the first positioning method and to stop positioning by the second positioning method (step S27). When the server 30 determines that the wearable terminal 10 has not passed the measurement point CP, the server 30 continues to transmit the second positioning result.

The wearable terminal 10 instructed by the server 30 to perform the positioning by the first positioning method stops executing the positioning by the second positioning method (step S08), operates the first positioning circuit 11 to start the execution of the positioning by the first positioning method (step S09), and acquires the first positioning result. Thereafter, although details are omitted, operations from step S03 and subsequent steps described above are repeated. Accordingly, when there are a plurality of the measurement points CP, it is possible to record the passage time of each measurement point CP, record a passage time of the goal, and check the approximate passage route.

The position management system 100 or a control method thereof according to the first embodiment described above is the position management system 100 or the control method thereof that manages the position of the target person US using the server 30, the device 110 attached to the target person US, and a plurality of apparatuses 120 disposed in a predetermined range set in advance, that is, the check area AI, the position information about the device 110 acquired by the first positioning method of acquiring the position information based on the satellite signal is acquired from the device 110 that executes the first positioning method, it is determined whether the target person US is present in the check area AI, when it is determined that the target person US is present in the check area AI, the device 110 is caused to stop the execution of the first positioning method, and the device 110 is caused to acquire the position information by the second positioning method different from the first positioning method, and the second positioning method is a positioning method of measuring the position of the device 110 based on the relative positions between the plurality of apparatuses 120 and the device 110.

The second positioning method is a positioning method for measuring the position of the device 110 based on the relative positions between the plurality of apparatuses 120 and the device 110. Therefore, for example, the position of the device 110 can be accurately determined by the second positioning method in a predetermined area including the measurement point, even when positioning satisfying necessary accuracy cannot be performed by the first positioning method due to the influence of multipath.

### Second Embodiment

Hereinafter, a position management system and a control method thereof according to a second embodiment of the present disclosure will be described. The position management system according to the second embodiment is a partial modification of the position management system according to the first embodiment, and description of portions common to those of the position management system according to the first embodiment will be omitted.

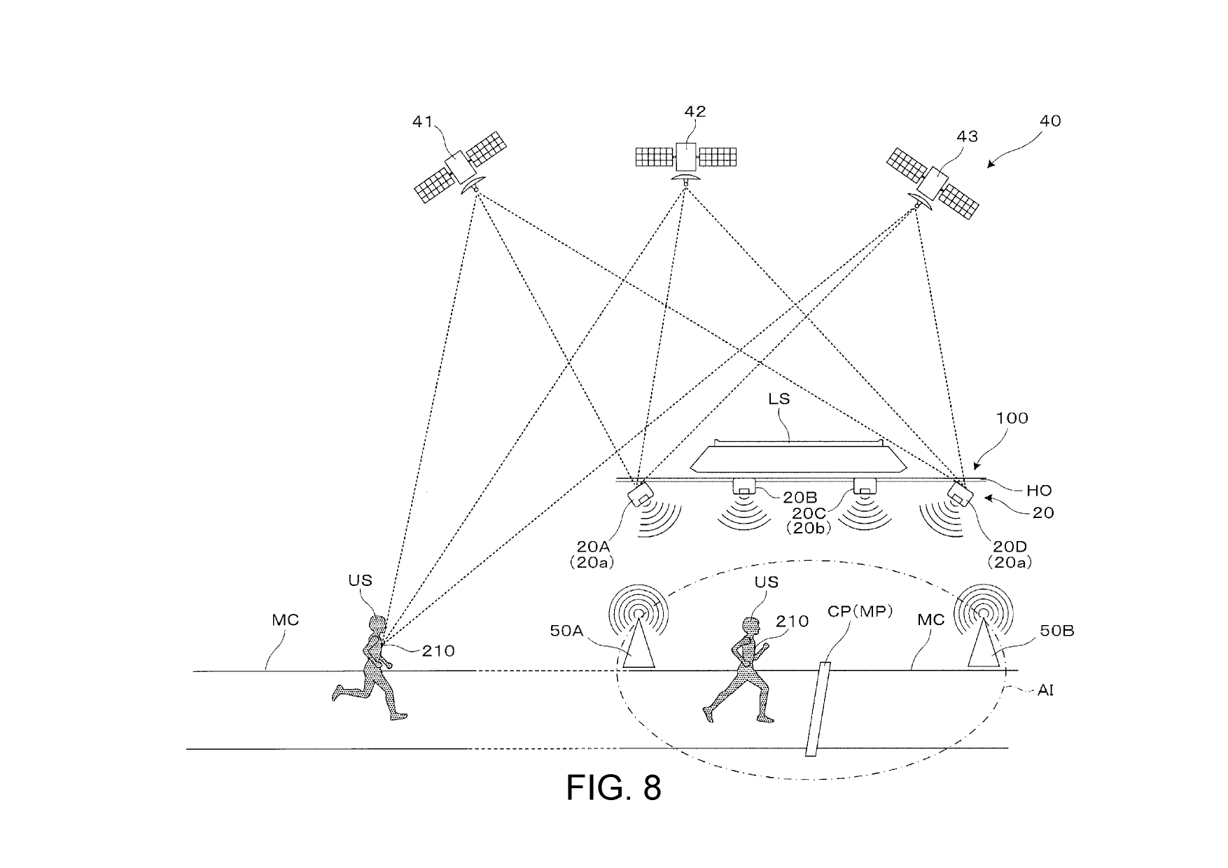

As illustrated in FIG. 8, the position management system 100 additionally includes a first monitoring unit 50A that is disposed corresponding to one of outer edges of the check area AI, which is a predetermined range, along the course MC and that acquires device information about a wearable terminal 210, and a second monitoring unit 50B that is disposed corresponding to the other of the outer edges of the check area AI, which is a predetermined range, along the course MC and that acquires the device information about the wearable terminal 210. The positioning anchors 20A, 20B, 20C, and 20D constituting the anchor set 20 can communicate with each other. Among these positioning anchors 20A, 20B, 20C, and 20D, two positioning anchors 20A and 20D disposed outdoors are first apparatuses 20a that acquire position information indicating positions where the positioning anchors 20A and 20D are disposed using the first positioning method, two positioning anchors 20B and 20C disposed indoors are second apparatuses 20b, and position information in which the positioning anchors 20B and 20C are disposed is acquired based on a relative position between the positioning anchors 20A and 20D, which are first apparatuses 21a, and the positioning anchors 20B and 20C. That is, the two positioning anchors 20B and 20C are blocked by a structure LS such as a roof, and cannot perform satellite positioning by the first positioning method. However, satellite positioning by the first positioning method is possible for the two positioning anchors 20A and 20D disposed outdoors of the structure LS. The two positioning anchors 20B and 20C that are not disposed outdoors of the structure LS can detect their own positions with the same accuracy as the positioning anchors 20A and 20D based on first positioning results of the two positioning anchors 20A and 20D serving as references and the relative position information with respect to the positioning anchors 20A and 20D.

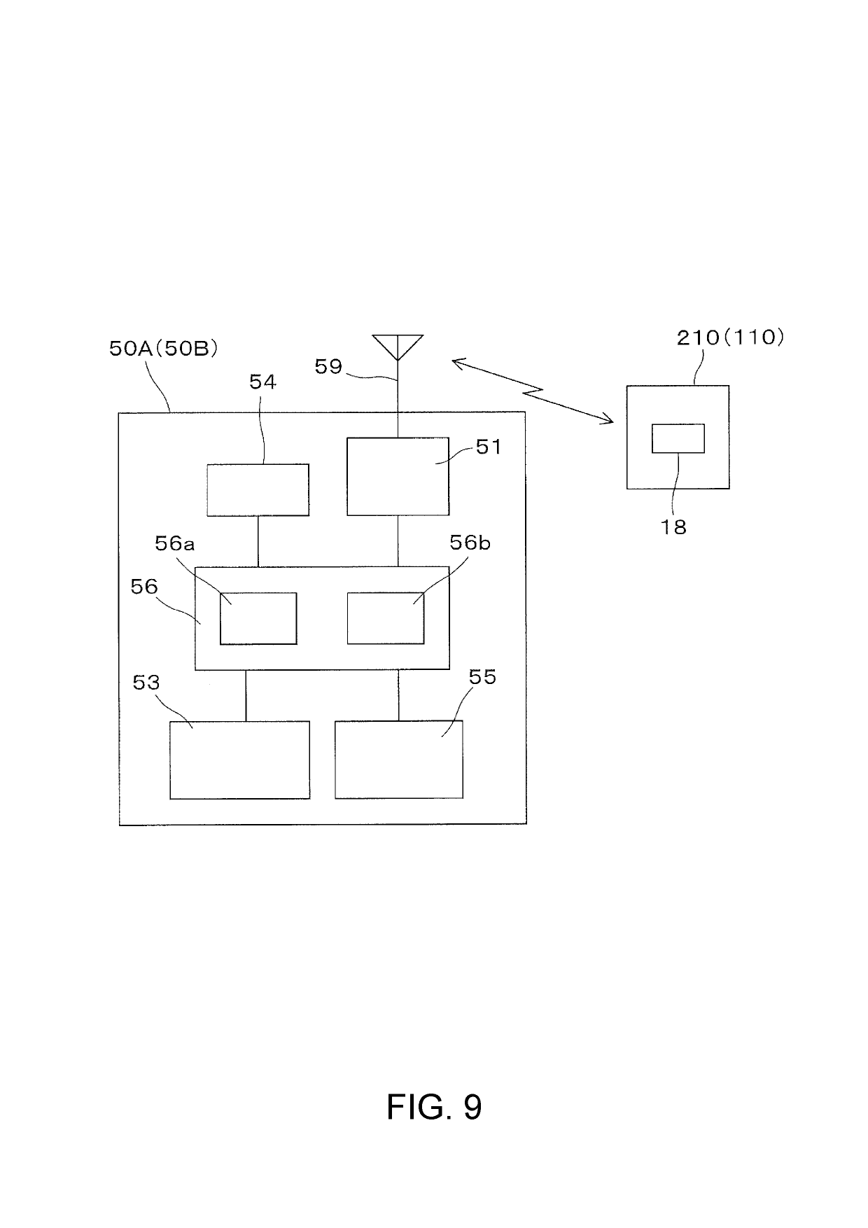

Referring to FIG. 9, the first monitoring unit 50A is a tag reader and reads identification information set in the wearable terminal 210 from a wireless tag circuit 18 incorporated in the wearable terminal 210. The first monitoring unit 50A includes a transmission and reception circuit 51 with an RFID wireless tag, a communication device 53 that performs wireless communication with the server 30, an input and output device 54 that receives information necessary for operating the first monitoring unit 50A and outputs a processing result and a state, a storage device 55 that stores a program for operating the first monitoring unit 50A, and a control circuit 56 that operates the transmission and reception circuit 51 to acquire tag information including the identification information. The control circuit 56 includes a CPU 56a and a memory 56b, and operates based on an installed program. The first monitoring unit 50A outputs a radio wave of a predetermined band from an antenna 59 via the transmission and reception circuit 51, receives a response wave from the wearable terminal 210 present in the vicinity, identifies the wearable terminal 210, and acquires necessary information from the wearable terminal 210. The communication device 53 exchanges digital information with the server 30 by inter-terminal wireless communication such as a wireless LAN.

Since the second monitoring unit 50B has the same structure as the first monitoring unit 50A and functions in the same manner as the first monitoring unit 50A, the description thereof will be omitted. However, the first monitoring unit 50A is disposed on an inlet side of the check area AI, and the second monitoring unit 50B is disposed on an outlet side of the check area AI. That is, when the first monitoring unit 50A detects the wearable terminal 210, it means that the runner who is the target person US is approaching the measurement point CP, and when the second monitoring unit 50B detects the wearable terminal 210, it means that the runner who is the target person US has passed the measurement point CP and is moving away. In this case, the server 30 can confirm that the specific wearable terminal 210 has entered the check area AI and approaches the measurement point CP based on detection information from the first monitoring unit 50A, and can instruct the specific wearable terminal 210 to start positioning by the second positioning method, that is, to perform positioning by the second positioning method.

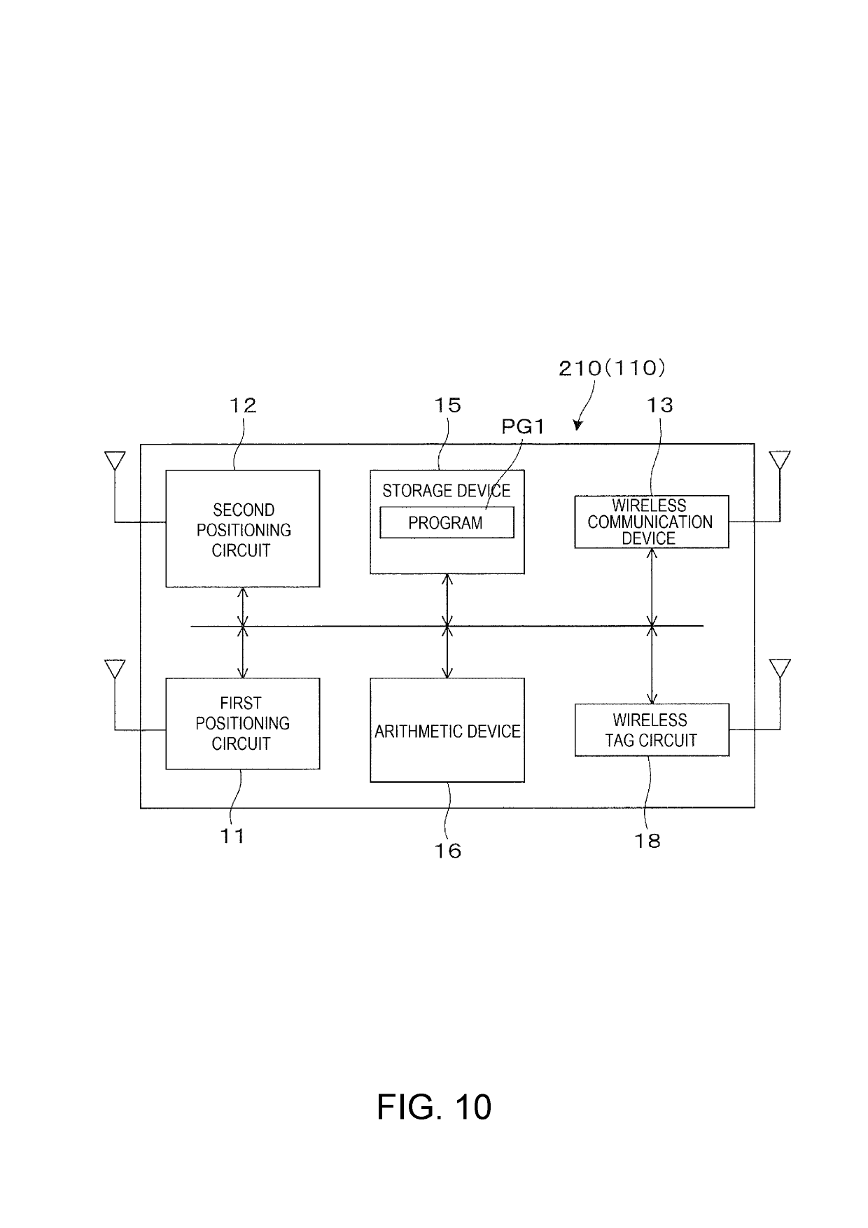

FIG. 10 is a block diagram illustrating the wearable terminal 210. A difference from the wearable terminal 10 according to the first embodiment illustrated in FIG. 2 is that the wireless tag circuit 18 functioning as an RFID wireless tag is added.

In the case of the present embodiment, when the first monitoring unit 50A on the inlet side communicates with the specific wearable terminal 210 and acquires identification information about the wearable terminal 210, the first monitoring unit 50A transmits the identification information about the wearable terminal 210 to the server 30, and the server 30 instructs the wearable terminal 210 of the received identification information to start positioning by the second positioning method. In contrast, when the second monitoring unit 50B on the outlet side communicates with the specific wearable terminal 210 and acquires the identification information about the wearable terminal 210, the second monitoring unit 50B transmits the identification information about the wearable terminal 210 to the server 30, and the server 30 can perform an operation of instructing the wearable terminal 210 of the received identification information to stop the positioning by the second positioning method. However, the present disclosure is not limited thereto. When the wearable terminal 210 detects the first monitoring unit 50A, the arithmetic device 16 of the wearable terminal 210 may operate the second positioning circuit 12, start positioning by the second positioning method, and transmit an obtained second positioning result to the server 30. In addition, when the wearable terminal 210 detects the second monitoring unit 50B, the arithmetic device 16 of the wearable terminal 210 may stop an operation of the second positioning circuit 12.

The positioning executed by the first positioning circuit 11 of the wearable terminal 210 can be stopped when identification is established between the first monitoring unit 50A and the wearable terminal 210. When the wearable terminal 210 receives the UWB communication signal, the positioning executed by the first positioning circuit 11 of the wearable terminal 210 may be stopped, or the positioning may be stopped when the wearable terminal 210 moves into the structure LS and cannot acquire a satellite signal.

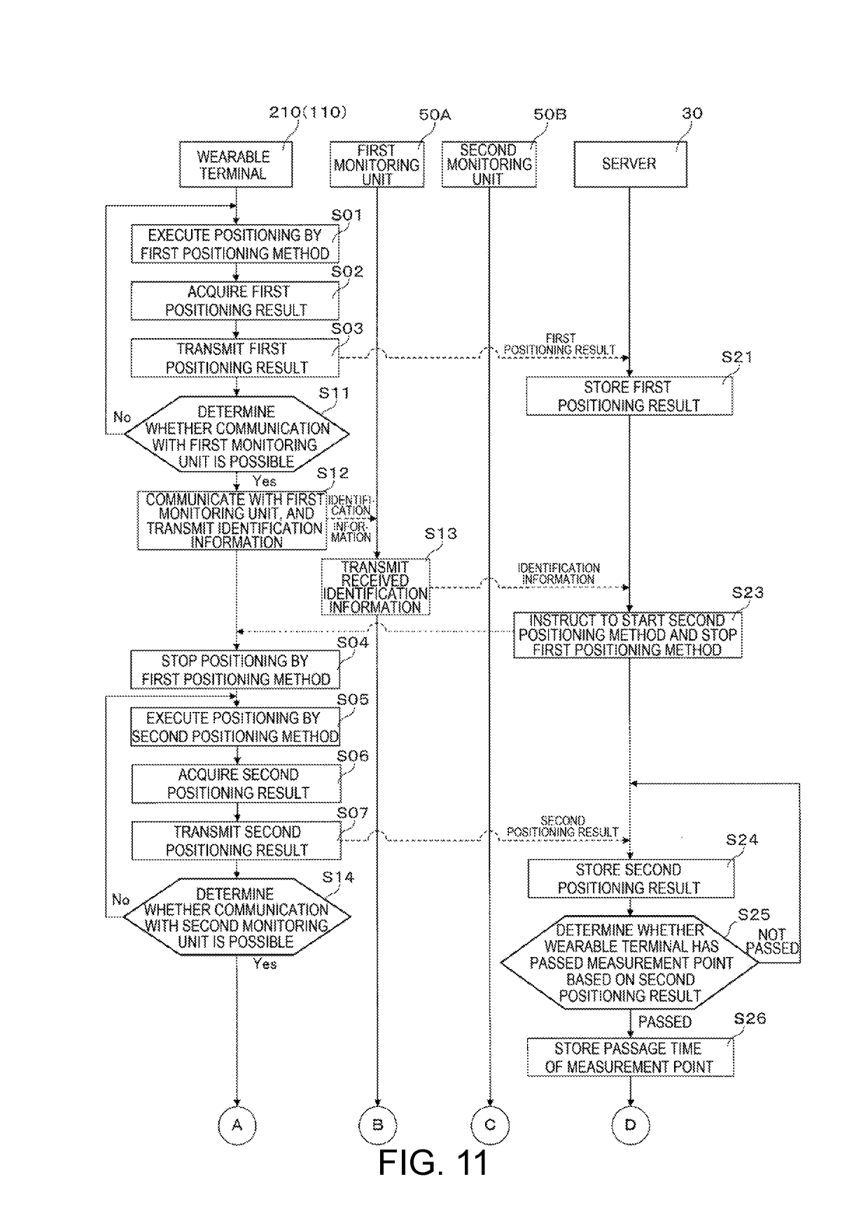

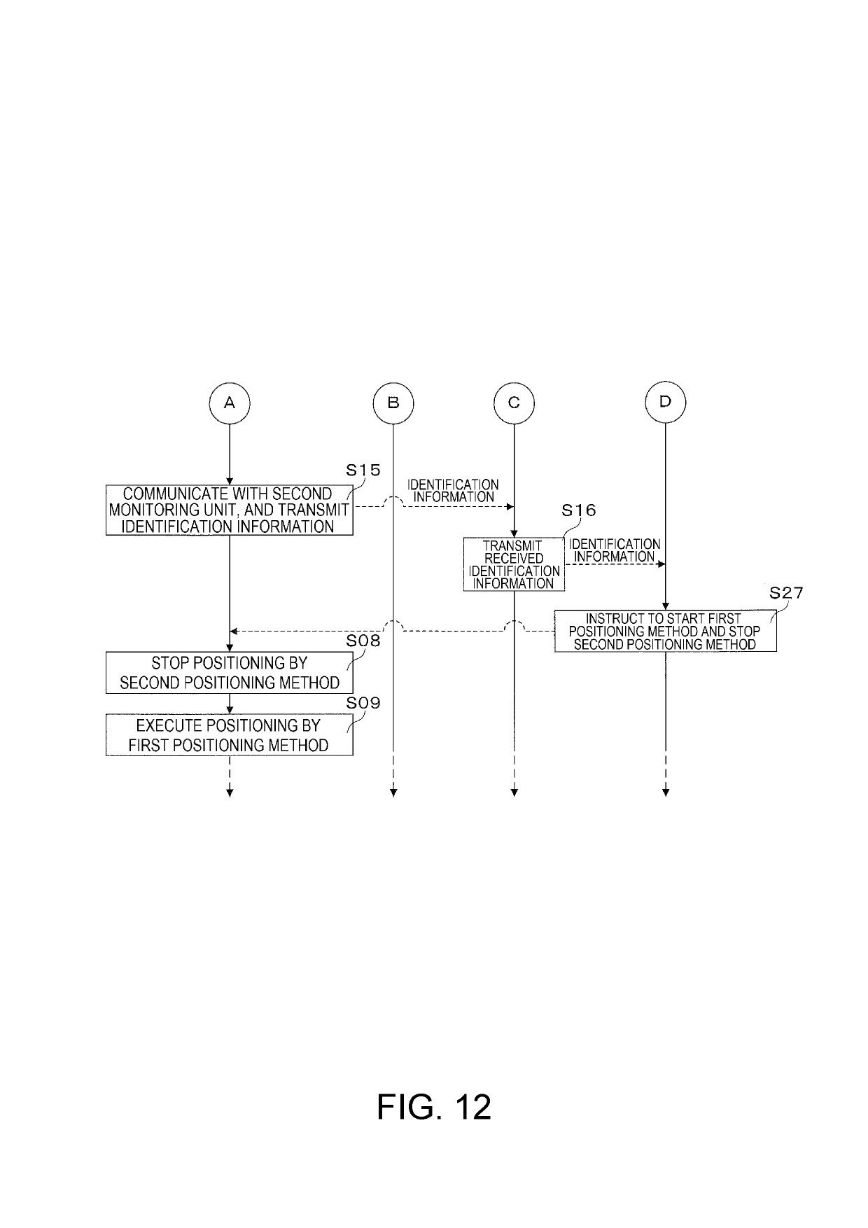

An example of operations of the position management system 100 will be described with reference to FIGS. 11 and 12. First, the wearable terminal 210 operates the first positioning circuit 11 to start execution of positioning by the first positioning method (step S01), and acquires the first positioning result (step S02). When the first positioning result is acquired, the wearable terminal 210 transmits the first positioning result to the server 30 (step S03).

The server 30 that receives the first positioning result stores the first positioning result (step S21).

In parallel with this storage, the wearable terminal 210 determines whether communication is established between the wearable terminal 210 and the first monitoring unit 50A (step S11), and when the communication with the first monitoring unit 50A can be performed, the wearable terminal 210 transmits the identification information about the wearable terminal 210 to the first monitoring unit 50A (step S12). When communicating with the wearable terminal 210 and receiving the identification information from the wearable terminal 210, the first monitoring unit 50A transmits the identification information about the wearable terminal 210 to the server 30 (step S13). The server 30 that receives the identification information about the wearable terminal 210 instructs the wearable terminal 210 to start positioning by the second positioning method and to stop positioning by the first positioning method (step S23).

The wearable terminal 210 instructed to perform the positioning by the second positioning method from the server 30 stops the execution of the positioning by the first positioning method (step S04), operates the second positioning circuit 12 to start the execution of the positioning by the second positioning method (step S05), and acquires the second positioning result (step S06). When the second positioning result is acquired, the wearable terminal 210 transmits the second positioning result to the server 30 (step S07). The wearable terminal 210 repeatedly acquires the second positioning result, and when the second positioning result is acquired, the wearable terminal 210 sequentially transmits the second positioning result to the server 30.

The server 30 that receives the second positioning result stores the second positioning result (step S24), and determines whether the wearable terminal 210, that is, the target person US has passed the measurement point CP based on the second positioning result (step S25). When the server 30 determines that the wearable terminal 210 has passed the measurement point CP, the server 30 records a passage time of the measurement point CP (step S26).

In parallel with this record, the wearable terminal 210 determines whether communication is established between the wearable terminal 210 and the second monitoring unit 50B (step S14), and when the communication with the second monitoring unit 50B can be performed, the wearable terminal 210 transmits the identification information about the wearable terminal 210 to the second monitoring unit 50B (step S15). When communicating with the wearable terminal 210 and receiving the identification information from the wearable terminal 210, the second monitoring unit 50B transmits the identification information about the wearable terminal 210 to the server 30 (step S16). The server 30 that receives the identification information about the wearable terminal 210 instructs the wearable terminal 210 to start positioning by the first positioning method and to stop positioning by the second positioning method (step S27).

The wearable terminal 210 instructed to perform the positioning by the first positioning method from the server 30 stops the execution of the positioning by the second positioning method (step S08), operates the first positioning circuit 11 to start the execution of the positioning by the first positioning method (step S09), and acquires the first positioning result. Thereafter, although details are omitted, operations from step S03 and subsequent steps described above are repeated.

### Other Matters

The structures described above are presented by way of examples, and can be changed in various manners within a scope in which the same functions can be obtained. For example, the position management system 100 can be applied not only to a marathon but also to various competitions in which players move.

The second positioning circuit 12 may perform positioning using UWB communication in a broad sense instead of UWB communication in a narrow sense. The second positioning circuit 12 may perform positioning by inter-terminal wireless communication such as Bluetooth.

The anchor set 20 may be installed not only around the measurement point CP through which runners pass but also at the goal.

The second positioning method is not limited to a method for measuring distances to the positioning anchors 20A, 20B, and 20C, and may be a method for determining relative positions by determining orientations in which the positioning anchors 20A, 20B, and 20C are present.

### Summary of Disclosure

The present disclosure will be summarized below as appendices.

### Appendix 1

A control method for a position management system that manages a position of a target person using a server, a device attached to the target person, and a plurality of apparatuses disposed in a predetermined range set in advance, the control method including:

acquiring, from the device configured to execute a first positioning method for acquiring position information based on a satellite signal, the position information about the device acquired by the first positioning method; determining whether the target person is present in the predetermined range; and causing the device to acquire the position information by a second positioning method different from the first positioning method when it is determined that the target person is present in the predetermined range, in which the second positioning method is a positioning method for measuring a position of the device based on relative positions between the plurality of apparatuses and the device.

The second positioning method is a positioning method for measuring the position of the device based on the relative positions between the plurality of apparatuses and the device. Therefore, for example, the position of the device can be accurately determined by the second positioning method in a predetermined area including the measurement point, even when positioning satisfying necessary accuracy cannot be performed by the first positioning method due to the influence of multipath.

### Appendix 2

The control method according to Appendix 1, in which

the target person is a person who passes through a predetermined course, and

the predetermined range includes a predetermined measurement location on the course.

In this case, the time when the device, that is, the target person passes through the measurement location can be accurately detected by the second positioning method.

### Appendix 3

The control method according to Appendix 2, in which

the second positioning method is a positioning method for measuring the position of the device based on the relative positions between the plurality of apparatuses and the device calculated by performing UWB communication, and

it is determined whether the target person passes through the measurement location based on the position information about the device acquired by the second positioning method.

By using precise UWB communication, it is possible to accurately determine the passage time of the measurement location. A range in which UWB communication can be performed can be set as the predetermined range.

### Appendix 4

The control method according to Appendix 3, in which

among the plurality of apparatuses used in the second positioning method, a first apparatus is an apparatus configured to acquire position information indicating a position where the first apparatus is disposed using the first positioning method.

It is possible to set and specify the position where the first apparatus is disposed with high accuracy based on satellite information without being set by a person.

### Appendix 5

The control method according to Appendix 4, in which

among the plurality of apparatuses used in the second positioning method, a second apparatus different from the first apparatus acquires position information indicating a position where the second apparatus is disposed based on a relative position between the first apparatus and the second apparatus.

Even when the first apparatus is disposed at a position where the GNS cannot be received, the position can be automatically set and specified.

### Appendix 6

The control method according to any one of Appendices 1 to 5, in which

it is determined whether the target person is present in the predetermined range based on the position information about the device acquired by the first positioning method.

In this case, it is possible to switch from the first positioning method to the second positioning method using the result of the first positioning method.

### Appendix 7

The control method according to Appendix 6, in which

the predetermined range is a range in which the UWB communication in a broad sense is possible between the device and the first apparatus.

### Appendix 8

The control method according to Appendix 7, in which

the device is caused to stop execution of the second positioning method and is caused to execute the first positioning method when it is determined that the target person passes through a measurement point.

Switching from positioning using UWB communication to satellite positioning can be performed.

### Appendix 9

The control method according to any one of Appendices 1 to 5, in which

device information about the device is acquired from a first monitoring unit disposed corresponding to an outer edge of the predetermined range along the course, and

when the device information is acquired from the first monitoring unit, the device is caused to stop execution of the first positioning method and to execute the second positioning method.

In an indoor place where it is less likely to acquire the position information, the positioning method can be switched using the first monitoring unit as a trigger.

### Appendix 10

The control method according to Appendix 9, in which

the device information about the device is acquired from a second monitoring unit disposed corresponding to an outer edge of the predetermined range along the course, and

when the device information is acquired from the second monitoring unit, the device is caused to stop execution of the second positioning method and to execute the first positioning method.

### Appendix 11

A control method for a position management system that manages a position of a target person using a server, a device attached to the target person, and a plurality of apparatuses disposed in a predetermined range set in advance, the method including:

executing, by the device, a first positioning method for acquiring position information based on a satellite signal;

acquiring, by the server, the position information about the device acquired by the first positioning method;

determining, by the server, whether the target person is present in the predetermined range; and

performing, by the server, control of causing the device to acquire the position information by a second positioning method different from the first positioning method when it is determined that the target person is present in the predetermined range, in which

the second positioning method is a positioning method for measuring a position of the device based on relative positions between the plurality of apparatuses and the device.

### Appendix 12

A position management system for managing a position of a target person using a server, a device attached to the target person, and a plurality of apparatuses disposed in a predetermined range set in advance, in which

from the device configured to execute a first positioning method for acquiring position information based on a satellite signal, the position information about the device acquired by the first positioning method is acquired,

whether the target person is present in the predetermined range is determined,

the device is caused to acquire the position information by a second positioning method different from the first positioning method when it is determined that the target person is present in the predetermined range, and

the second positioning method is a positioning method for measuring a position of the device based on relative positions between the plurality of apparatuses and the device.

### Appendix 13

The position management system according to Appendix 12, in which

the second positioning method is a positioning method for measuring the position of the device based on the relative positions between the plurality of apparatuses and the device calculated by performing UWB communication.

### Appendix 14

The position management system according to Appendix 12 or 13, in which

among the plurality of apparatuses used in the second positioning method, a first apparatus is an apparatus configured to acquire position information indicating a position where the first apparatus is disposed using the first positioning method.

### Appendix 15

The position management system according to any one of Appendices 12 to 14, in which

the server includes a display unit configured to display the position information acquired by the second positioning method and time information when the position information is acquired.

### Appendix 16

The position management system according to Appendix 15, in which

the server displays the position information in association with identification information about the device by the display unit.

What is claimed is:

1. A control method for a position management system that manages a position of a target person using a server, a device attached to the target person, and a plurality of apparatuses disposed in a predetermined range set in advance, the control method comprising:
acquiring, from the device configured to execute a first positioning method for acquiring position information based on a satellite signal, the position information about the device acquired by the first positioning method;
determining whether the target person is present in the predetermined range; and
causing the device to acquire the position information by a second positioning method different from the first positioning method when it is determined that the target person is present in the predetermined range, wherein
the second positioning method is a positioning method for measuring a position of the device based on relative positions between the plurality of apparatuses and the device.

2. The control method according to claim 1, wherein
the target person is a person who passes through a predetermined course, and
the predetermined range includes a predetermined measurement location on the course.

3. The control method according to claim 2, wherein
the second positioning method is a positioning method for measuring the position of the device based on the relative positions between the plurality of apparatuses and the device calculated by performing UWB communication, and
it is determined whether the target person passes through the measurement location based on the position information about the device acquired by the second positioning method.

4. The control method according to claim 3, wherein
among the plurality of apparatuses used in the second positioning method, a first apparatus is an apparatus configured to acquire position information indicating a position where the first apparatus is disposed using the first positioning method.

5. The control method according to claim 4, wherein
among the plurality of apparatuses used in the second positioning method, a second apparatus different from the first apparatus acquires position information indicating a position where the second apparatus is disposed based on a relative position between the first apparatus and the second apparatus.

6. The control method according to claim 5, wherein
it is determined whether the target person is present in the predetermined range based on the position information about the device acquired by the first positioning method.

7. The control method according to claim 6, wherein
the predetermined range is a range in which UWB communication is possible between the device and the first apparatus.

8. The control method according to claim 7, wherein
the device is caused to stop execution of the second positioning method and to execute the first positioning method when it is determined that the target person passes through a measurement point.

9. The control method according to claim 2, wherein
device information about the device is acquired from a first monitoring unit disposed corresponding to an outer edge of the predetermined range along the course, and
when the device information is acquired from the first monitoring unit, the device is caused to stop execution of the first positioning method and to execute the second positioning method.

10. The control method according to claim 9, wherein
the device information about the device is acquired from a second monitoring unit disposed corresponding to an outer edge of the predetermined range along the course, and
when the device information is acquired from the second monitoring unit, the device is caused to stop execution of the second positioning method and to execute the first positioning method.

11. A control method for a position management system that manages a position of a target person using a server, a device attached to the target person, and a plurality of apparatuses disposed in a predetermined range set in advance, the method comprising:
executing, by the device, a first positioning method for acquiring position information based on a satellite signal;
acquiring, by the server, the position information about the device acquired by the first positioning method;
determining, by the server, whether the target person is present in the predetermined range; and
performing, by the server, control of causing the device to acquire the position information by a second positioning method different from the first positioning method when it is determined that the target person is present in the predetermined range, wherein
the second positioning method is a positioning method for measuring a position of the device based on relative positions between the plurality of apparatuses and the device.

12. A position management system for managing a position of a target person using a server, a device attached to the target person, and a plurality of apparatuses disposed in a predetermined range set in advance, wherein
from the device configured to execute a first positioning method for acquiring position information based on a satellite signal, the position information about the device acquired by the first positioning method is acquired,
whether the target person is present in the predetermined range is determined,
the device is caused to acquire the position information by a second positioning method different from the first positioning method when it is determined that the target person is present in the predetermined range, and
the second positioning method is a positioning method for measuring a position of the device based on relative positions between the plurality of apparatuses and the device.

13. The position management system according to claim 12, wherein
the second positioning method is a positioning method for measuring the position of the device based on the relative positions between the plurality of apparatuses and the device calculated by performing UWB communication.

14. The position management system according to claim 12, wherein
among the plurality of apparatuses used in the second positioning method, a first apparatus is an apparatus configured to acquire position information indicating a position where the first apparatus is disposed using the first positioning method.

15. The position management system according to claim 12, wherein
the server includes a display unit configured to display the position information acquired by the second positioning method and time information when the position information is acquired.

16. The position management system according to claim 15, wherein
the server displays the position information in association with identification information about the device by the display unit.
